(19) United States
(12) Patent Application Publication
(10) Pub. No.: US 2011/0135834 A1
(43) Pub. Date: Jun. 9, 2011

(54) MODULAR TRANSFER APPARATUS AND PROCESS

(76) Inventors: Juan Schneider, Laval (CA); Gillers Picard, Trois-Rivieres (CA)

(21) Appl. No.: 12/309,855

(22) PCT Filed: Aug. 2, 2007
(86) PCT No.: PCT/CA2007/001334

§ 371 Date: Nov. 23, 2010

Related U.S. Application Data
(60) Provisional application No. 60/834,790, filed on Aug. 2, 2006.

(51) Int. Cl. B05D 1/26; B05C 5/02

(52) U.S. Cl. 427/420; 118/300

(57) ABSTRACT

The present invention concerns an apparatus, a process and a cartridge for producing and transferring a thin film to a substrate withdrawing the thin film. The apparatus includes the substrate, a transfer lip, a gap defined between the substrate and the transfer lip and a liquid film supported on the transfer lip and carrying a thin film in a direction towards and into the gap, the liquid of the liquid film forming a capillary bridge spanning the length of the gap and supporting the thin film over the gap onto the substrate. The process includes the steps of supplying the liquid film, positioning the transfer lip and substrate, supporting the liquid film towards and into the gap, forming the capillary bridge and withdrawing the thin film. The modular cartridge is also described.

### BACKGROUND OF THE INVENTION

1. Technical Field

The present invention relates to an apparatus and process for transferring a thin film onto a substrate.

2. Description of the Prior Art

WO98/53920 discloses a method and apparatus that produces monolayers of particles. The apparatus comprises a cylindrical rotary member from whose outer surface a thin liquid film containing the monolayer of particles have their surface charge density adjusted. The rotary member transfers the monolayer on to a substrate that withdraws the monolayer of particles. The rotary member and the surface of the substrate comprising the monolayer of particles, moving in opposite directions away from one another. Typically, the substrate is placed below the rotary member and the monolayer transfer occurs on a substantially horizontal plane.

A linear coating device is described in U.S. Patent application 2005129867 A1 for the production of industrial monolayers and thin films, where particles are deposited on a carrier fluid flowing by gravity along a ramp. At the bottom of the ramp the particles are held back and form a monolayer of particles that are tightly packed. This tight packing causes the particles to be piled up on and against one another in a monolayer configuration which is taken by the carrier fluid towards a moving substrate onto which the monolayer or thin layer of particles is transferred. This invention uses a substrate conveyor moving the substrate from one spool to another while withdrawing the monolayer or thin layer away from the carrier fluid. The substrate is immersed in a bath of the carrier fluid before coating, thus increasing the amount of liquid that needs to be evaporated from the transferred monolayer on the substrate and treated in a solvent recovery system. Furthermore, a large volume of contaminated carrier fluid needs to be disposed of after each coating run, and due to the proximity of the transfer component with the substrate conveyor, maintenance of the equipment is at times difficult.

U.S. Pat. No. 5,455,062 by Mühlfriedal et al, discloses a coating method that reduces the amount of solvent that needs to be evaporated by coating or lacquering a film of solvent onto a substrate using a capillary device and without immersion of the substrate in the carrier fluid. This device uses a liquid in an open channel which forms a convexly curved portion projecting upwardly from the open channel. The channel is placed at a close distance towards the plate to be coated. The liquid passes through a capillary slot that is filled with the liquid coating medium. The plate to be coated is advanced across the capillary slot with the surface to be coated facing downwardly so that due to a capillary effect a thin layer is deposited on the surface of the plate. This method is suitable for solvent coating. A similar coating and lacquering device is disclosed in U.S. Pat. No. 5,654,041 by Appich et al., that teaches a device for coating substrates having a capillary slot with an outlet opening.

U.S. Pat. No. 5,395,653 by Rasmussen discloses a method for coating flat substrates with a liquid. The method comprises pressurizing liquid within a coating head, the liquid having a specific viscosity forming a meniscus of liquid at an orifice in the coating head contacting the meniscus of liquid to the substrate to be coated and moving the meniscus relative to the substrate. Here too, the entire contents of liquid are coated onto the surface of the substrate through a capillary head.

The present invention seeks overcome the problems of the prior art and at the same time transfer a monolayer of particles and/or a thin film onto a substrate.

### SUMMARY OF THE INVENTION

The invention describes an apparatus and a process by which a monolayer or a thin layer of particles is transferred onto a substrate via a capillary bridge connection.

In accordance with one aspect of the present invention there is provided an apparatus for transferring a thin film comprising: a substrate withdrawing the thin film transferred thereupon; a transfer lip, a gap having a length defined between the substrate and the transfer lip; and a liquid film supported on the transfer lip, the liquid film carrying the thin film in a direction towards and into the gap, and the liquid of the liquid film forming a capillary bridge spanning the length of the gap and supporting the thin film over the gap onto the substrate.

In accordance with another aspect of the present invention there is provided a process for transferring a thin film to a substrate comprising steps of: supplying a liquid film carrying the thin film to a transfer lip; positioning the substrate across a gap opposite the transfer lip; supporting the liquid film on the transfer lip in a flow direction across and into the gap towards the substrate; forming a capillary bridge between the transfer lip and the substrate, the capillary bridge transferring the thin film from the transfer lip to the substrate, and withdrawing the substrate with the thin film transferred thereon.

In accordance with yet another aspect of the present invention there is provided a cartridge for transferring a thin film to a substrate withdrawing the thin film, the cartridge comprising: a housing comprising, a front, and a bottom wall, and the housing defining an internal chamber, an liquid inlet and a raw material inlet, and a transfer lip, wherein the liquid inlet and the raw material inlet are adapted to receive a liquid carrier and a film forming material respectively, wherein within the internal chamber along the bottom wall, the liquid carrier and the film forming material combine to produce a liquid film carrying a thin film of the film forming material to the front of the housing in the direction of the transfer lip and towards and into a gap defined between the substrate, the transfer lip adapted to retain the liquid film, the liquid film producing a capillary bridge in the gap over which the thin film is transferred to the substrate.

### BRIEF DESCRIPTION OF THE DRAWINGS

Further features and advantages of the present invention will become apparent from the following detailed description, taken in combination with the appended drawings, in which:

FIG. 1. is a side cross-sectional view of an apparatus in accordance with a preferred embodiment of the present invention including a representation of the substrate being coated;

FIG. 2a is a schematic side view of the apparatus of the present invention indicating the liquid flow pattern transporting the particulate dam in accordance with one embodiment of the present invention, in this case through the action of a pump;

FIG. 2b is a schematic side view of the apparatus of the present invention indicating the liquid flow pattern transporting the particulate dam in accordance with one embodiment of the present invention, in this case through the action of a gravitational force;

FIG. 2c is a schematic side view of the apparatus of the present invention indicating the liquid flow pattern transporting the particulate dam in accordance with one embodiment of the present invention, in this case through the action of a surface tension as a driving force;

FIG. 3 is an enlarged schematic cross sectional view of the capillary bridge generated by the apparatus in accordance with one embodiment of the present invention including a schematic representation of the monolayer coated on a surface of a substrate;

FIG. 4 is a enlarged cutaway cross section of a transfer lip in accordance with another embodiment of the present invention comprising a notch within the transfer lip;

FIG. 5 is a schematic perspective view of the forces exerted on a capillary bridge (PRIOR ART); and

FIG. 6 is a micrograph of one embodiment of a thin film produced by the process and apparatus of the present invention.

### DETAILED DESCRIPTION OF THE PREFERRED EMBODIMENT

Now referring to the drawings, the apparatus and the process for producing thin films of particles for industrial application will be described. The layers of particles can be well ordered in two dimensional arrays or crystals or be amorphous and porous if desired.

### The Thin Films Transferred According to the Present Invention

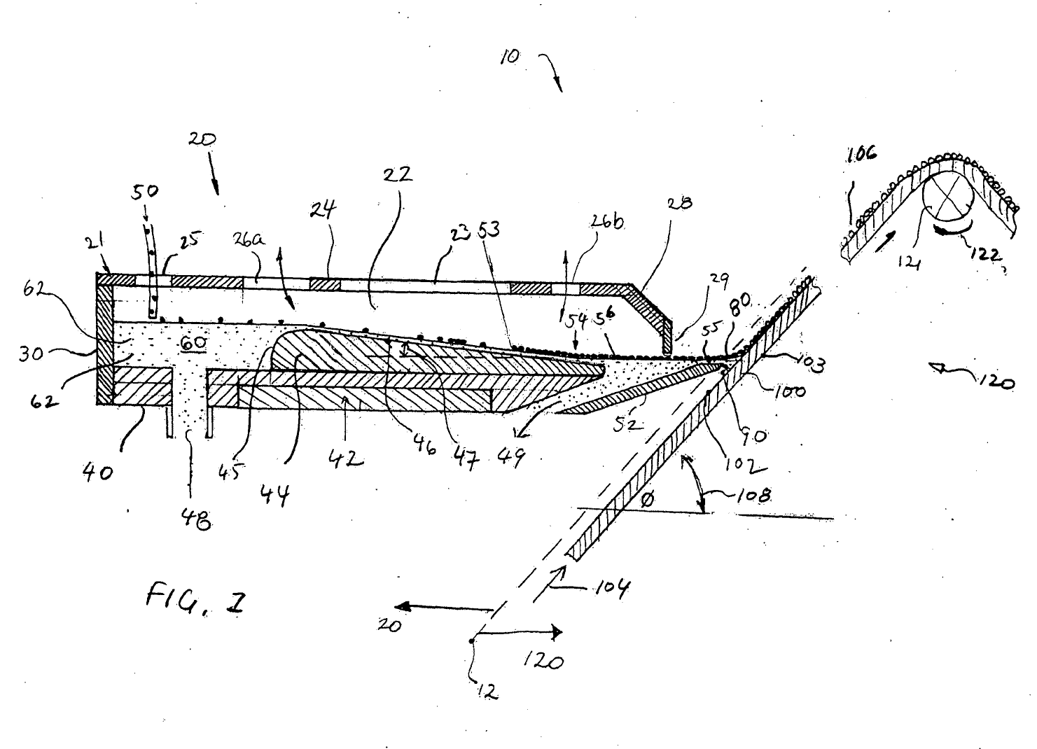

In reference to FIG. 1 the thin film 106 that is transferred by the modular coating apparatus 10 of the present invention may be any one of a variety of films. The thin film 106 transferred to substrate 100 of the present invention is defined as and understood to include the following films:
a) a monolayer of particles which may be i) amorphous or ii) crystalline. The amorphous monolayer of particles include an oriented material coatings which comprise phospholipids or surfactants. The crystalline monolayer of particles include hexagonal closed packed or orthogonal closed 2-dimensional crystals films;
b) ultra-thin films, typically including a variety of polymers and macromolecule, have a thickness in the order of 10 nm., or less; and
c) Bulk films range in thickness from 10 nm to several micron. Bulk films are understood to include any one of a large number of polymers, macromolecules and particles alone and combinations thereof. Coatings of bulk films are understood to have the same material properties as the material has when found in bulk.

The particles, polymers and macromolecules of these three types of films above are defined herein as film forming materials. These film forming materials may be in various physical forms that include: particulate solids, in suspension with liquids and in solution.

### The Cartridge

FIG. 1 illustrates one embodiment of the present apparatus 10 in cross-section. The apparatus 10 comprises at least two distinct and physically separate functional units: a cartridge 20; and a conveyor 120, the conveyor 120 displacing a substrate 100 onto which the thin film 106 will be transferred. Therefore one feature of the apparatus of the present invention is that it is modular in design.

In broad terms which will be explained in greater detail, the two functional units are separated by a narrow gap 90. A dashed line 12 in FIG. 1, is drawn through gap 90 and separates the cartridge 20 from the substrate conveyor 120. Although separate the units of the apparatus 10 are associated with each other through a liquid connection or capillary bridge 80. In a preferred embodiment the functional units are completely modular in design. The thin film 106 is produced, by way of the capillary bridge 80. FIG. 1 represents in a preferred embodiment the thin film 106 to be transferred that derives from a monolayer of solid particles 56 carried by a liquid film 54 on the surface of a liquid carrier 60, that is transferred from the cartridge 20 to the substrate 100 of the conveyor 120. The description of the workings of FIG. 1 will be described with reference to a monolayer of particles 106 but is also be applicable to the other types of thin films 106 previously described.

The cartridge 20 includes a housing 21 and a transfer lip 52, the transfer lip 52 is located at the front of the cartridge 20. The housing 21 comprises, a top wall 24, a back wall 30 and a bottom wall 40 which defines an internal chamber 22. In a preferred embodiment, the top wall 22 includes a plurality of gas ports 26a and 26b for gas/solvent circulation which are connected to a gas/vapour system (not shown). Arrows 27a and 27b indicate, the possible direction of gas/vapour flow from the gas ports 26a and 26b as either into or out of the internal chamber 22 of the cartridge 20.

The top wall 24 may include window 23, through which the liquid carrier 60 may be viewed by an operator. The top wall 24, in a preferred embodiment has a forwardly extending face 28 from which a gas exchange barrier plate 29 approaches the surface of the liquid carrier 60, where the barrier plate 29 is positioned at the front of the cartridge 20. In a preferred embodiment, the forwardly extending face 28 may also extend downwardly towards the liquid carrier 60.

The bottom wall 40 may include attached thereto, a heating or cooling pad 42. The heating or cooling pad 42 may be heated or cooled by means known to the skilled practitioner.

In a preferred embodiment, within the chamber 22 there may be a removable internal ramp 44 on the bottom wall 40. The ramp 44 is centrally located within the internal chamber 22 and defines a rearward facing fluid retaining wall 45. The liquid carrier 60, is retained in a reservoir 62 at the back of the internal chamber 22, between back wall 30 and the fluid retaining wall 45.

The raw materials, or film forming materials for the thin film 54, maybe in any one of a number of forms, including particulates, particulates in suspension and in solution. In the case of a thin film being transferred as a monolayer, particulate solids may be feed from that will forms the monolayer or thin layer film, are carefully feed through a raw material port 25 in the top wall 24, to the liquid surface of the reservoir 62 where the film forming materials 50 are carried on the surface of the liquid carrier 60. Although the description herein presented described a monolayer of particles is also equally valid to describing material previously described as producing thin films. The skilled practitioner would understand that the packing of particles, may be for a monolayer as well as for thin film, and these terms may be used interchangeably.

The liquid level of the reservoir 62 is such that it is slightly above the top of the ramp 44 and allows the liquid carrier 60 and carried particulate film forming materials 50 to flow down a sloped surface 46 due to hydrostatic pressure. The sloped surface 46 defines a ramp angle 47, such that near the base of the ramp 44 particles collect and produce a monolayer of particles 56 that are packed one against the other. This packing of particles can take various forms from: very tightly packed (with a steep ramp angle 47) to a loosely packed layer of particles (a gentle ramp angle 47).

It will be understood that the ramp angle 47 of more than 2° is sufficient to produce an adequate monolayer of particles or thin film packing. The level of packing required will vary from one application to another. Although angles from 2° to 20° have also been successfully employed. This packing up of particles is caused by the hydrodynamic flow of liquid carrier 60 as a thin liquid film 54 carrying the particles or the thin film, down the ramp 44. Although, the hydrodynamic pressure is one method that can be used to produce the liquid film 54 carrying a monolayer of particles 56, that will eventually become the monolayer or the thin film 106 on the substrate 100, other packing methods will also be described. Thus at the base of the ramp 44, a liquid film 54 is formed that includes a carrier liquid 60 and the monolayer layer of particles or the thin film 56, which in a preferred embodiment are tightly packed. The liquid film will have a width equal to that of the ramp 44 and the cartridge 20.

The means of particle supply or feeding and the formation of the packed monolayer of particles or the thin film 56 is similar to that found in U.S. Patent application 2005129867 A1, the contents of which are incorporated herein by reference.

The ramp 44 is positioned within the internal chamber 22 such that liquid carrier 60 flows in a direction towards the front of the cartridge 20.

In a preferred embodiment the liquid carrier 60 enters the internal chamber 22 via the liquid inlet port 48 defined in the bottom wall 40 adjacent the rear wall 30. In FIG. 1, the transfer lip is attached to the bottom wall 40. In the embodiment disclosed in FIG. 1 the liquid carrier 60 is circulated between the liquid inlet port 48 and withdrawn at a liquid outlet port 49 at the front of the cartridge 20 adjacent the transfer lip 52. In the circulation loop between the outlet port 49 and the inlet port 48 (not shown), the liquid carrier 60 may be treated to remove any remaining film forming materials 50 before being re-circulated back to liquid inlet port 48 (not shown).

Although much of the liquid carrier 60 is re-circulated, the liquid film 54 formed at the base of the ramp 44, continues and is supplied in a direction towards the transfer lip 52. The transfer lip 52 supports the liquid film 54 carrying the monolayer of particles 56. The liquid of the liquid film 54 flows over the lip 52 and into a gap 90 between the cartridge 20 and the substrate 100.

The size of the film forming materials, in the present example particles, 50 suspended on the liquid film 54 has been greatly exaggerated in FIG. 1 for greater clarity. The particles may be microscopic in nature although when the film forming material particles become packed together as a monolayer 56 they may become visible to the naked eye. Film forming materials used to make bulk films are typically visible to the naked eye.

The liquid 55 of the liquid film 54, that enters the narrow gap 90, produces a capillary bridge 80 between the transfer lip 52 and a film forming surface 102 on the substrate 100. The transfer lip 52 is adapted to retain the liquid film 54 on its outer surface. At steady operation, the capillary bridge 80 is such that only a small amount of liquid 60 is transferred with the monolayer of particles 56 that are withdrawn by the substrate 100. Thus the monolayer of particles or the thin film 106 is transferred onto the film forming surface 102 of the substrate 100 which includes only a very small amount of solvent, that needs to be evaporated.

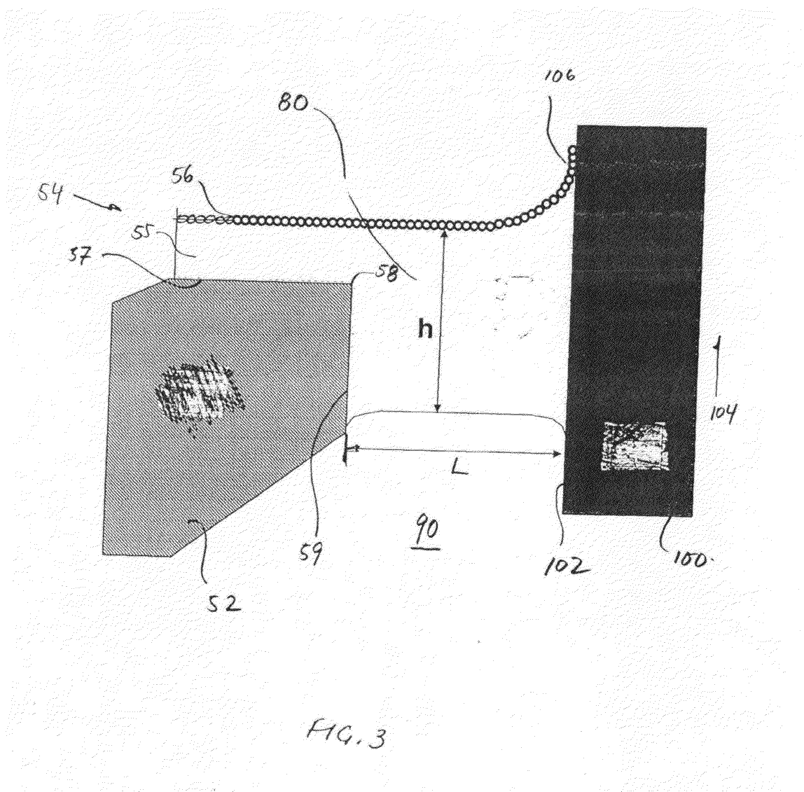

Substrate 100 is conveyed upwardly in a direction given by arrow 104, which is being driven by a conveyor 120 which is illustrated in FIG. 1 as a drive roll 121, whose rotation 122 moves the substrate 100, in the embodiment illustrated from a first roll (not shown) to the drive (or second) roll 121. The substrate may be inclined at wide range of contact angles 108 (represented by φ). In a preferred embodiment illustrated in FIG. 1 the angle 108 is acute (i.e. less than 90° to the horizontal plane). However, the transfer of the monolayer may also occur on a vertical surface (at a contact angle of 90° to the horizontal) as illustrated in FIG. 3. This alternative is particularly suitable if opposite surfaces 102 and 103 of the substrate 100 are coated simultaneously. Although not illustrated, the contact angles 108 that are obtuse (greater than 90° to the horizontal plane) have also been successfully transferred.

The principles governing the present process are similar to those described in the spreading unit of U.S. application 2005129867 A1. The film forming materials particle placed on the surface of the liquid carrier 60 are spread at the surface of the fluid and then forced downward towards a formation line 53 by a flow pressure. A gentle ramp angle 47, along with producing sufficient particle packing, also reduces flow instabilities 47. Moreover, a low flow rate of liquid carrier 60 between liquid inlet 48 and liquid outlet 49 ensures that liquid flows are well-controlled, and helps to ensure cleanliness and working conditions of the surroundings.

As previously mentioned, a gas, typically: air, dehumidified air or inert gas, can be circulated to either create an aerodynamic pressure or control the gas mixture above the monolayer of particles or the thin film 56 on the liquid film 54 though ports 26a and 26b.

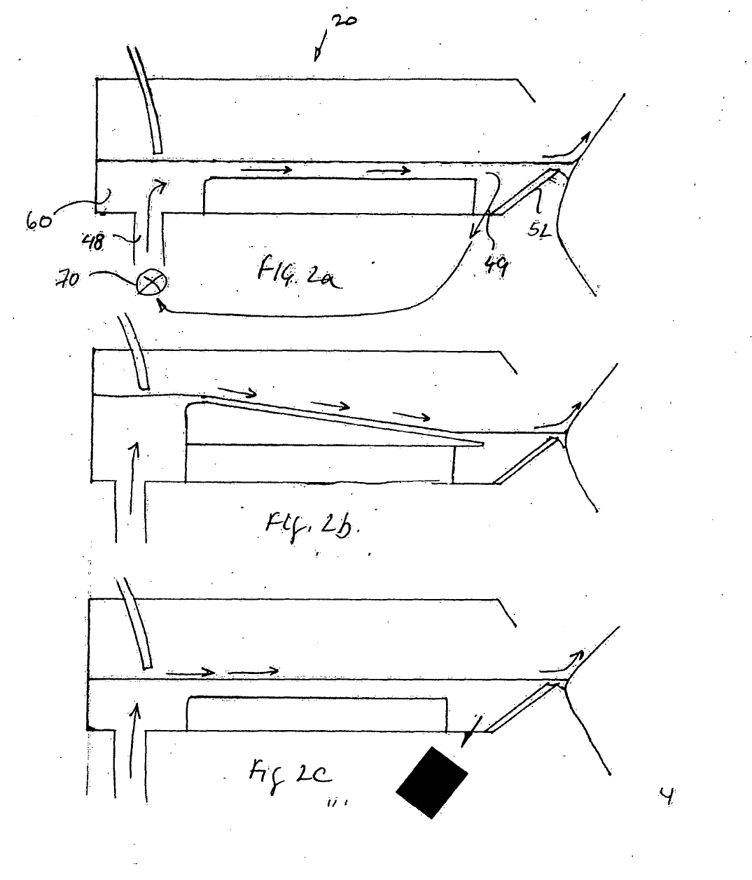

Referring to FIGS. 2a, 2b and 2c, they illustrate three different liquid flow pattern configurations within the cartridge 20 of the present invention. Each figure presents a different method to generate a driving force by which the packed film forming materials may be formed to produce a monolayer of particles or a thin film 56 that can be transferred to the substrate 100.

In FIG. 2a, the flow of the liquid carrier 60 alone generates the driving force to form the film forming materials layer or thin film 56 near the transfer lip 52 of the cartridge 20. The liquid carrier 60 is driven by the action of a pump 70 between the liquid inlet 48 and outlet 49 of the cartridge 20.

FIG. 2b illustrates an embodiment very similar to that of FIG. 1 where the hydrostatic head generates the driving force through the flow of the liquid carrier 60, this flow pattern is particularly applicable to transferring a monolayer of particles, as well as, to ultra-thin films.

In FIG. 2c the driving force for the formation of packed particles 56 is subtle and is due to a surface tension differential between the carrier liquid 60 and the suspension or solution that is placed at the surface of the carrier liquid. The driving force is provided by the natural spreading force of solvents at the air/liquid carrier interface, and liquid carrier 60 recirculation is performed for cleaning and refreshing purposes. The flow patterns of FIGS. 2a and 2c are particularly suitable for the thin film applications producing bulk films such as polymers, however they also be used with monolayers of particles and ultra-thin films.

The transfer lip 52 of the cartridge 20 may have a width (out of the plane of FIG. 1) that is narrow (a few centimeters in length) or relatively long (up to several meters). The width of the transfer lip 52 is typically the width of the housing 21 although it may be wider or narrower than the housing 21. A single or several adjacent cartridges side-by-side may be used. Face to face cartridges can be used in order to simultaneously coat the front and the back of a rigid or flexible substrate, or a conveyor. The production of multiple monolayers can also be envisaged with multiple cartridges 20 superimposed one on the other. Furthermore, these multiple cartridges 20 may coat the same or different materials. The cartridges 20 are designed to be easily replaced and are so designed as to allow a gas flow to add an aerodynamic pressure to the hydrodynamic one generated by the liquid carrier. Furthermore, the gas may be inert or reactive. In the case where the gas is reactive it may be designed to react with the particle or the solvent. Furthermore, the gas may be either cooled or heated so as to increase or decrease the solvent evaporation rates and thus help to assist in the design of gas/solvent, capture and recovery system for a particular application.

The cartridge 20 of the present invention is similar to that known for computer printer systems and would allow operators to change various films on the same day. The cost, maintenance and emission control system requirements of the present invention are expected to be reduced as compared to those for the U.S. application 2005129867 A1. The modular design is also expected to simplify maintenance and reduce maintenance costs.

### The Substrate Conveyor, 120

The substrate conveyor 120 of the present invention, is a simple piece of equipment that may be installed and adjusted (a the gap 90) and does not require immersion into a solvent bath. The conveyor 120 may be a standard piece of equipment available on the market and known to the skilled practitioner and ensures that the substrate surface 102 moves in relation to the cartridge 20 and thus allows the transfer of the monolayer of particles or the thin film to the surface 102 of the substrate 100. In the alternative, the cartridge 20 may be placed on a conveyor (not shown) while the substrate 100 remains stationary. The types of substrate conveyors 120 envisaged include: roll-to-roll equipment and rigid handlers of wafers, photomasks, Flat Panels to name a few that would be known to the skilled practitioner.

The substrate 100 onto which the monolayer or thin film is transferred may be oriented in a direction 104. The web may be rolled up in a first spool which is unrolled by the substrate conveyor 120 in the direction 104 onto a second spool. The substrate 102 may be anyone of various materials that would be known to the skilled practitioner, including: a webs of thin plastic, paper, fabric, or metallic foils onto which the monolayer is transferred.

### The Capillary Bridge, 80

FIG. 3 illustrates an enlarged schematic cross-section of the capillary bridge 80 of the present invention which is formed between the transfer lip 52 which includes a first surface 57, an adjacent second surface 59 and an edge 58 therebetween. FIG. 3 represents the situation where the substrate 100 is not moving or moving very slowly (in terms of mm./sec) with respect to the transfer lip 52, in direction 104. It must also be emphasized that FIG. 3 is not to scale, as both the size of the layer of particles or the thin film 56 are greatly exaggerated. Furthermore, the dimensions of L and h are also oversized as represented in FIG. 3. The transfer lip 52 is adjacent and in close proximity to the film forming surface 102 of the substrate 100 between which the capillary bridge 80 is formed. The length and height of the capillary bridge 80 are indicated as L and h in FIG. 3 respectively, and in a preferred embodiment of the present invention are in the sub-millimeter and millimeter range respectively In simple terms, the capillary bridge 80 is basically a thin liquid span connecting the transfer lip 52 and the substrate 100, which extends outwardly from the transfer lip 52.

The liquid film 54 and the monolayer particles 56 flow over the first surface 57 towards the substrate 100. The first surface 57 of the transfer lip 52 supports the liquid film 54 is in a preferred embodiment, substantially horizontal.

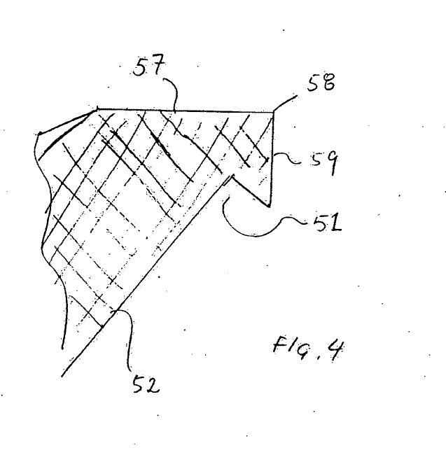

FIG. 4 represents another embodiment of the transfer lip 52, which includes a first substantially horizontal surface 57 meeting a second substantially vertical surface 59 at edge 58. The second surface 59 ends at a bottom edge in a notch 51 that is upwardly projecting defined within the transfer lip 52. The shortened second surface 59 of this embodiment helps to retain the liquid at the lower edge of the second surface, thus further improving the stability of the capillary bridge. The notch 51 is in a preferred embodiment coated with a hydrophobic material such as Teflon™, also improving the liquids retention of the second surface 59.

Referring once again to FIG. 3, the monolayer of particles or the thin film 56 suspended on the upper surface of the liquid film 54 and a lower curved surface of liquid carrier 60 are both exposed to a gas phase in the gap 90 between the transfer lip 52 and the substrate surface 102.

It should be understood that as the speed of the substrate 100 increases in the direction 104, from the slow transfer illustrated in FIG. 3, in a range less than 1 mm/sec, to higher speeds from 1 to 10 mm/sec the shape of the lower portion of the capillary bridge 80 adjacent the substrate 100, will deform and curve upwardly in the direction 104 of the moving substrate 100.

The length or distance, L, that may be spanned by a particular capillary bridge 80 is dependent on the physical properties of a liquid carrier 60 used. The properties governing the distance L that can be spanned by a particular liquid primarily include: surface tension, liquid density and gravitational force. The liquid carrier producing the liquid film may be any liquid where the surface tension is used to spread the material at the carrier liquid surface. In a preferred embodiment, the liquid carrier is selected from the group consisting of water, ethanol, methanol, acetone, heptane and hexane. In a particularly preferred embodiment the liquid carrier 60 is water or a water based solution thereof.

Referring to FIG. 3, the capillary distance, which is referred to as K⁻¹ is the distance spanning the gap 90, up to where the surface tension of the liquid exerts its presence, modifying the profile of the liquid, or in other terms, is the limit at which the force gravity starts exerting its influence on the capillary bridge 80. If the length L of the capillary bridge is less than this capillary distance K⁻¹ is an indication of the expected stability of the capillary bridge transferring the monolayer of particles 56 to the substrate 100 will be high.

The theoretical capillary distance (Reference: “Gouttes, bulles, perles et ondes”, translation—“Drops, bubbles, pearls and waves” authored by P-G. de Gennes, F. Brochard-Wyart et D. Quéré 255 pages, Editions Belin, 2002) spanned between vertical plates is expressed as:

K⁻¹=(γ/ρg)^{1/2}

where γ is the surface tension of the carrying liquid, ρ the density of the carrying liquid, and g the gravitational acceleration. If the length of the gap L, is less than the value of K⁻¹ then the capillary bridge 80 spanning the gap 90 will be stable.

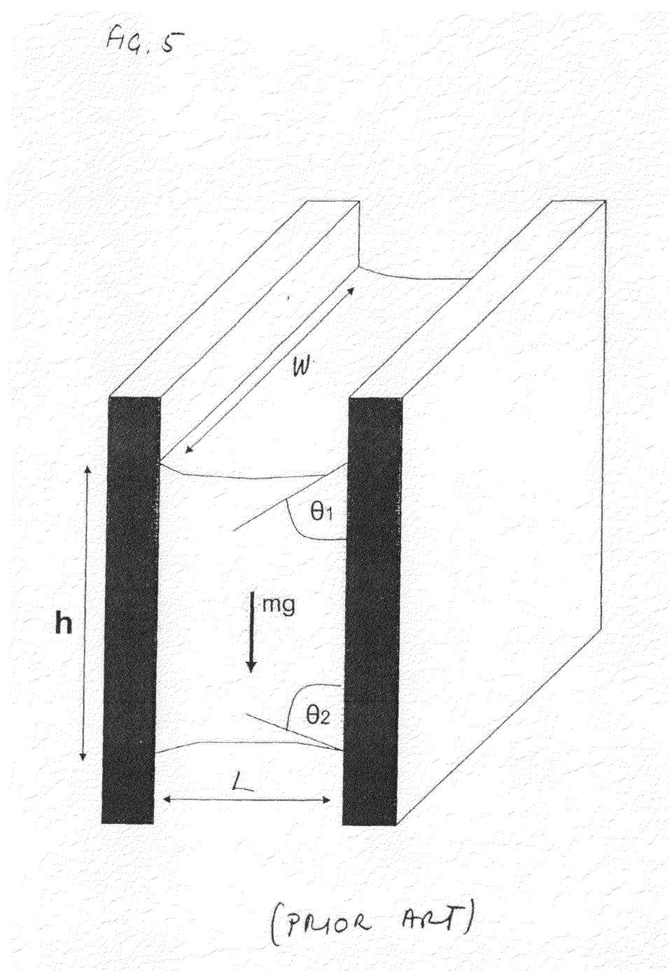

Now referring to FIG. 5, L is the length of the capillary bridge 80. For most liquids, including mercury, the capillary distance, K⁻¹ is about 2 mm., and is typically in the millimeter range of values. When the gap length of the capillary bridge is less than 2 mm the capillary bridge will tend to be stable. In a preferred embodiment the length L, of capillary bridge of the present invention is in the sub-millimeter (less than 1 mm.) range and easily adjusted mechanically.

When transferring the layer of particles or the thin film 56, the balance of forces at play is complex and formulating equations describing the transfer of the monolayer onto the substrate are difficult to deduce. However, the following parameters will have an effect on the transfer and must be considered: the surface tension of the fluid, combined with the monolayer surface pressure on the length of span of the bridge; the hydro-affinity and surface roughness of the transfer lip 52 surfaces 57, 59 and the substrate 100 from which and onto which the monolayer is transferred; the speed at which the monolayer or thin film is transferred to the substrate; mechanical vibrations and variations in the gap 90 during transfer during the rolling or transferring process; the flow of fluid that remains trapped between the monolayer and the substrate and finally the length and the confinement of the bridge are all interacting together as well as the length, the width and the volume of the bridge, and the angle of contact (φ) 110 of the translated or rolling substrate. However despite the complexity of the mathematical equations required to explain the transfer, in practice, the capillary bridge 80 is very robust and sustains the stressed which are exerted on it, for instance, the micron to nano-particles monolayer, as well as thin and relatively thick films. This is particularly true for the case when the carrier liquid used is water.

FIG. 5 further represents, the capillary bridge under static conditions (that is the system is not transferring the monolayer or thin film) the bridge volume is describe by the equation:

V_{c}=LWh with L=C/h

where C=2γ(cos θ₁−cos θ₂)/ρg is a constant for a set of materials defining the contact angles and liquid surface tension γ, and W is the width of the capillary bridge.

### Adaptability of the Process of the Present Invention

The cartridge 20 is positioned adjacent and in close proximity to the substrate 100 which withdraws a monolayer 106 by the action of conveyer 120. The cartridge 20 and the substrate 100 are associated by the capillary bridge 80. The length of the bridge 80 can be adjusted by means of a positioning system. However, in a preferred embodiment the length L of the gap 90 remains substantially constant during transfer of the monolayer 56.

Various surfaces were coated with this method, for instance wafers, glass slides and quartz plates for photomask. Monolayers made of elements, as well as molecules of thin films from photoresists formulae, were used successfully.

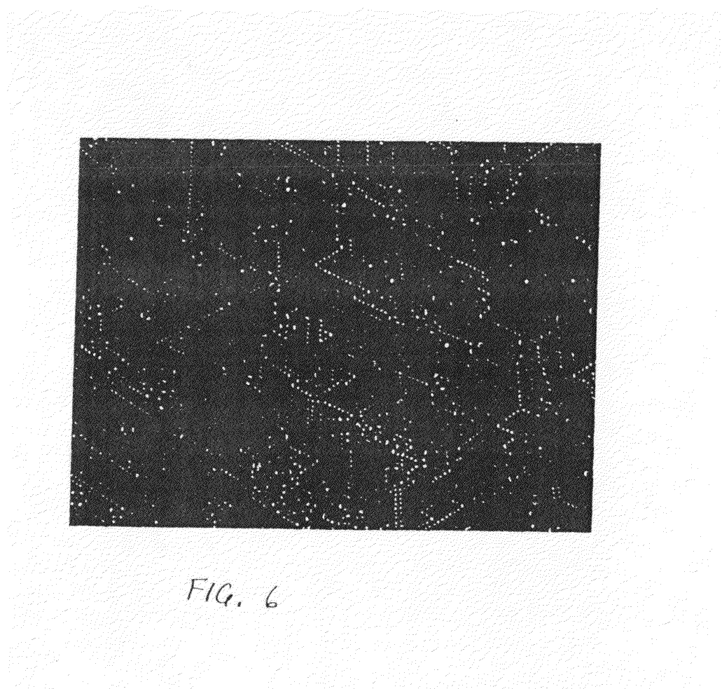

It is interesting to note that even for a transfer of a micron size monolayer of particles, the process and the apparatus of the present invention work equally well. FIG. 6 illustrates a portion of a monolayer that was produced at high speed (in the order of 3 mm/sec). This monolayer of spherules with a diameter of one micron was prepared with the modular set-up of the present invention. FIG. 6 illustrates the same typical features such as hexagonal closed-pack 2-D crystals, lines between crystals, and voids. Moreover, the monolayer or film quality is excellent, and is equal to or better than that achieved by the single block configuration of U.S. Patent application 2005129867 A1.

The potential applications for the monolayer or thin films of the present invention include: fuel cells, monolayers for optical, photonics, patterning catalyst and/or functional surfaces; polymer coatings, resists for lithography wafers, photomasks, flat panel displays, dielectrics, protective barriers for moisture, anti-reflective coatings; and bio-sensors, MEMS, NEMS, filters (optical, gas and liquid) and protective films for photomasks.

The embodiment(s) of the invention described above is(are) intended to be exemplary only. The scope of the invention is therefore intended to be limited solely by the scope of the appended claims.

1. An apparatus for transferring a thin film comprising:
a substrate withdrawing the thin film transferred thereupon;
a transfer lip;
a gap having a length defined between the substrate and the transfer lip; and
a liquid film supported on the transfer lip, the liquid film carrying the thin film in a direction towards and into the gap, and the liquid of the liquid film forming a capillary bridge spanning the length of the gap and supporting the thin film over the gap onto the substrate.

2. The apparatus of claim 1, wherein the length of the gap being substantially constant during transfer of the monolayer of particles to the substrate.

3. The apparatus of claim 1, wherein the gap is less than a capillary distance determined by
(γ/ρg)^{1/2}
wherein γ is the surface tension of the liquid, ρ is the density of the liquid, and g gravitational acceleration.

4. The apparatus of claim 1, wherein the liquid is a water based solution.

5. The apparatus of claim 1, wherein the transfer lip comprises:
a first surface having an outward edge adjacent the gap; and
a second surface meeting the first surface at the edge.

6. A process for transferring a thin film to a substrate comprising steps of:
supplying a liquid film carrying the thin film to a transfer lip;
positioning the substrate across a gap opposite the transfer lip;
supporting the liquid film on the transfer lip in a flow direction across and into the gap towards the substrate;
forming a capillary bridge between the transfer lip and the substrate, the capillary bridge transferring the thin film from the transfer lip to the substrate; and
withdrawing the substrate with the thin film transferred thereon.

7. The process of claim 6, wherein the supplying of the liquid film carrying the thin film is via a ramp within a cartridge.

8. The process of claim 6, wherein the supplying the liquid film carrying the thin film is via a pump.

9. A cartridge for transferring a thin film to a substrate withdrawing the thin film, the cartridge comprising:
a housing comprising, a front, and a bottom wall, and the housing defining an internal chamber, an liquid inlet and a raw material inlet; and
a transfer lip,
wherein the liquid inlet and the raw material inlet are adapted to receive a liquid carrier and a film forming material respectively,
wherein within the internal chamber along the bottom wall, the liquid carrier and the film forming material combine to produce a liquid film carrying a thin film of the film forming material to the front of the housing in the direction of the transfer lip and towards and into a gap defined between the substrate, the transfer lip adapted to retain the liquid film, the liquid film producing a capillary bridge in the gap over which the thin film is transferred to the substrate.

10. The cartridge of claim 9, wherein the transfer lip comprises:
a first surface on which the liquid film is supported, the first surface having an outward edge facing the substrate; and
a second surface meeting the first surface at the edge.

11. The cartridge of claim 10, wherein at least one of the first and the second surfaces comprises a low friction hydrophobic material.
